(19) United States
(12) Patent Application Publication
(10) Pub. No.: US 2002/0083344 A1
(43) Pub. Date: Jun. 27, 2002

(54) Integrated intelligent inter/intra networking device

(76) Inventor: Kannan P. Vairavan, Cupertino, CA (US)

Correspondence Address: FENWICK & WEST LLP, TWO PALO ALTO SQUARE, PALO ALTO, CA, 94306, US

(21) Appl. No.: 09/894,224

(22) Filed: Jun. 27, 2001

Related U.S. Application Data
(60) Provisional application No. 60/258,156, filed on Dec. 21, 2000.

(51) Int. Cl. G06F 11/30

(52) U.S. Cl. 713/201; 709/223

(57) ABSTRACT

An integrated, easily upgradeable networking device capable of interfacing with different types of networks while still providing high performance networking functionalities such as protocol conversion, security maintenance, and inter/intra-network management within an enterprise environment is described. The device may perform various networking functions within an enterprise and is easily adaptable to perform bother inter-networking functions as well as intra-networking functions.

### CROSS-REFERENCE TO RELATED APPLICATIONS

This application claims priority from provisional U.S. Patent Application Ser. No. 60/258,156, “Integrated Intelligent Inter-Intra (ICUBE) Network Box,” by Kannan P. Vairavan, filed Dec. 21, 2000. The subject matter of which is herein incorporated by reference in its entirety.

### BACKGROUND

A. Technical Field

The present invention relates generally to the field of enterprise networking and more particularly to the field of inter/intra-networking interfacing between various types of networks such as copper-based, optical, and wireless.

B. Background of the Invention

The continual improvement of technology within the networking industry is well known in the art. The industry is constantly trying to expand on current networking technology as well as develop alternative technology with corresponding advantages over more traditional networking technology. In response, protocols and standards are created and updated in order to ensure that both a compatibility and performance levels are maintained within the industry. Within this environment, it is difficult to maintain an up-to-date, diverse networking enterprise.

The infrastructure in a large enterprise containing both computer systems and networks of different types is very complex. This complexity increases as the number of different networking types, standards, and protocols integrated within an enterprise increases. Complicated functions such as protocol conversion, security maintenance, and inter/intra-networking management must occur at a large number of networking interfaces within the enterprise. As a result, the design and actual implementation of an enterprise requires both a large expenditure of time and money. However, as networking technology changes, this design may quickly become obsolete. Due to the complexity of enterprise infrastructures, upgrading an obsolete infrastructure is generally very costly as well. In fact, oftentimes, networking devices (e.g., gateways, bridges, and routers) are discarded and replaced with versions containing newer technology. As a result, the cost of maintaining a stable enterprise is usually very high; frequently higher than the initial design and implementation costs. Nowhere is this problem more relevant than in the office networking arena.

Typically, an office enterprise employs multiple networks of various types. For example, such an enterprise may include a wireless network (e.g., a Bluetooth compatible network), a wide area cable network, and multiple copper based local area networks. Additionally, the enterprise may need to interface with fiber optic networks such as metro area networks or long-haul networks. Each of these different types of networks operates according to corresponding protocols and standards. Thus, the combination of these varying networks within an enterprise requires a high level of complexity to achieve a workable combination that is sufficiently reliable for an office environment.

Office enterprises often require additional or stricter network functions above those offered in more traditional networks. For example, certain businesses may require a high level of security within their network to protect valuable data. Additionally, businesses may require certain network management functions in order to properly operate within an office environment. These various functionality levels within different interfacing networks amplify the complexity of an enterprise infrastructure containing these networks.

In the past, companies have been purchasing computers, cables and wires with various networking components that require addressing complex compatibility issues when integrated within the same enterprise. Expensive experts are required to both install and maintain these systems. Additionally, networking technologies in this market place have been changing at a rapid pace in order to feed an ever-increasing hunger for bandwidth and network functionalities within the office networking arena. Although these advancements provide network administrators many advantages, these advantages come at a cost. Specifically, networks and corresponding enterprises must be upgraded in order to incorporate these technology advances. This upgrade is typically very expensive due to the price of the new networking devices as well as the cost in integrating these devices within existing infrastructures.

Today there are many alternative ways of providing internet and intranet connectivity within an enterprise. For example, xDSL, fiber and wireless mediums have both advantages and disadvantages with respect to each other. The amount of research and development in each of these mediums in order to maximize these advantages and minimize these disadvantages is well known. As a result, the rate at which these technologies are likely to improve will not decrease. Thus, currently operating networks will likely need to be upgraded frequently in the future to incorporate these technological advances. Additionally, the complexity of enterprise infrastructures containing these networks and corresponding functionality demands on these networks will likely increase.

Conventional systems have attempted to address the problems discussed above. These systems use networking devices that connect various different computing devices operating according to different protocols and standards. As described above, networking technology is emerging very rapidly with various standards resulting in inter-operability issues due to proprietary standards. These networking devices fall short in addressing current and future enterprise infrastructure problems because of the following reasons:

(1) creating a simple networking device that is compatible with multiple networking technologies and may interface with different types of networks;

(2) providing a networking device that is relatively simple to maintain;

(3) offering a networking device that is easily upgradeable and is not discarded as an enterprise infrastructure expands; and

(4) including appropriate network functions within the box and allowing these network functions to grow or contract as a network's needs change.

Accordingly it is desirable to provide an integrated, easily upgradeable networking device capable of interfacing with different types of networks while still providing high performance networking functionalities such as protocol conversion, security maintenance, and inter/intra-network management within an enterprise environment.

### SUMMARY OF THE INVENTION

The present invention overcomes the deficiencies and limitations of the prior art by providing an inter/intra-networking device that is:

(1) compatible with multiple networking technologies and may interface with different types of networks;

(2) simple to maintain;

(3) easily upgradeable; and

(4) provides scalable network functionality to support an enterprise as it expands or changes.

The inter/intra-networking device comprises a plurality of access device cards, a packet processor, a security processor, a system processor and a switching fabric.

The access device cards support various access devices that may interface with the inter/intra-networking device. Specifically, these access device cards support various types of mediums on which the access device may operate. Examples of these mediums include copper-based (e.g., DSL, cable, POTS), fiber (e.g., fiber-to-the-home, MAN), and wireless (e.g., Bluetooth, wireless ISP, and wireless LAN) connections. Importantly, these cards are easily replaced so that if a new access device must be connected, a corresponding card is inserted into the particular access point. Additionally, the cards support bandwidth-enhancing applications such as bonding as well. The physical connections within the inter/intra-networking device are not disturbed because the cards are designed to be compatible with each component of the inter/intra-networking device. As a result, any upgrading process within the enterprise is vastly simplified and less costly.

The packet processor performs various security, routing, encryption/decryption and management functions on packets received from the access device cards. Specifically, the packet processor supports numerous encryption/decryption protocols so that the inter/intra-networking device may interface with different types of networks. Additionally, this feature allows any upgrading of access device cards to be much simpler as encryption technology does not need to be converted to another format prior to reception in the packet processor. The packet processor also performs multiple security features for both the inter/intra-networking device as well as devices on attached networks. This feature allows the functionality within an enterprise to be centralized so that both enterprise maintenance and service is simplified. The packet processor also supports various routing protocols and methods, which once again further enhances the inter/intra-networking device to incorporate various types of networks within the enterprise.

The security processor operates both independently and in cooperation with the packet processor in the creation and maintenance of secured virtual private network connections within attached networks. Specifically, the security processor supports multiple encryption/decryption protocols, such as Internet Protocol Security (“IPSec”), to create and maintain security associations between devices within the enterprise. These associations allow the transmission of secure packets across a public network. Furthermore, the security processor supports other encryption protocols that allow it to operate in different types of virtual private networks. The centralization of these functions as well as the large number of protocols supported allows the inter/intra-networking device to perform numerous networking functions (e.g. network router, end router) and still be easily upgraded and maintained.

The system processor configures each of the components within the inter/intra-networking device to function properly as well as coordinates and supervises each these components. The system processor is coupled to each component via a plurality of control lines so that management data may be communicated quickly and efficiently. Also, software upgrades may be pushed from the system processor to each component; thereby reducing complexity of any internal upgrades to the device. The system processor operates with the packet processor to perform various security functions both on a network level and a device level. Additionally, the system processor provides the switching fabric with numerous routing protocols and information to enable the switching fabric to route packets containing various types routing protocol information. Importantly, the system processor facilitates the easy upgrading of the access device cards and centralizes the majority of the management functions within a single processing module.

The switching fabric is coupled to the packet processor and system processor. The switching fabric includes numerous network ports that may connect to various different local area networks and/or private networks, or may connect to a single network. These ports are easily adaptable to a wide range of different enterprise designs. The switching fabric also includes a routing table that is easily configurable. The majority of routing protocols and functions are stored in and retrieved from the system processor. As a result, the compatibility of the switching fabric with any particular routing protocol may be addressed at the system processor.

Overall, the inter/intra-networking device provides network/enterprise managers with a device that may be easily implemented in any network or enterprise design. Additionally, the device provides a centralized enterprise/network management and offers an easy upgrading process when the enterprise is altered or expanded.

### BRIEF DESCRIPTION OF THE DRAWINGS

FIG. 1 is an illustration of an enterprise network and an inter/intra networking device in accordance with one embodiment of the present invention.

FIG. 2 is a general block diagram of an embodiment of the inter/intra networking device according to one embodiment of the present invention.

FIG. 3 is a block diagram of an embodiment of a packet processor found within the inter/intra networking device according to one embodiment of the present invention.

FIG. 4 is a block diagram of an embodiment of a security processor found within the inter/intra networking device according to one embodiment of the present invention.

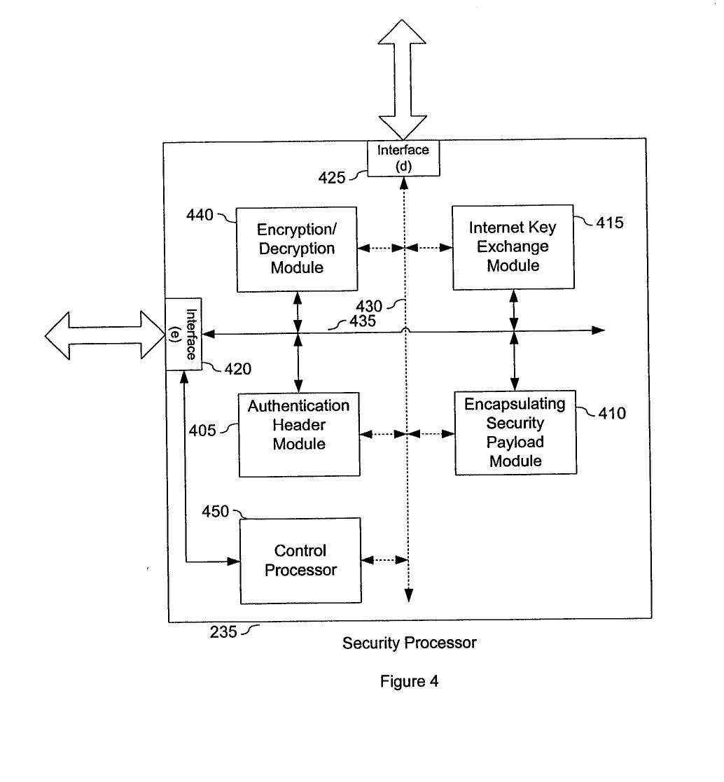

FIG. 5 is a block diagram of an embodiment of a system processor found within the inter/intra networking device according to one embodiment of the present invention.

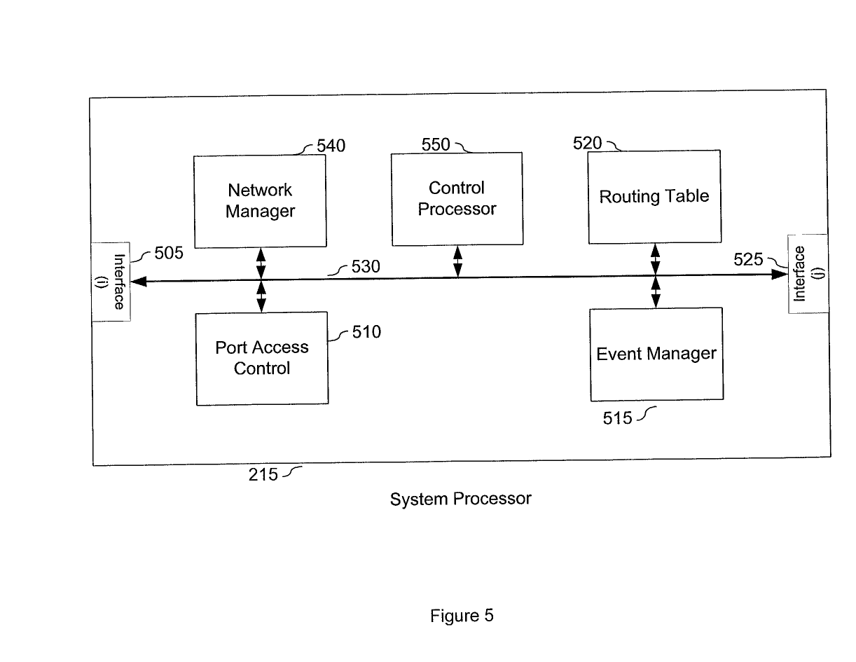

FIG. 6A is a flow diagram of a method for receiving a packet from a network according to one embodiment the present invention.

FIG. 6B is a flow diagram of a method for securing and routing a packet according to one embodiment of the present invention

FIG. 7 is a flow diagram of a method for decrypting and routing a packet according to one embodiment of the present invention.

FIG. 8 is a flow diagram of a method for receiving and routing a wireless packet according to one embodiment of the present invention.

FIG. 9 is a flow diagram of a method for encrypting and routing a packet according to one embodiment of the present invention.

FIG. 10 is a flow diagram of a method for securing and transmitting a wireless packet according to one embodiment of the present invention.

The figures depict a preferred embodiment of the present invention for purposes of illustration only. One skilled in the art will recognize from the following discussion that alternative embodiments of the structures and methods illustrated herein may be employed without departing from the principles of the invention described herein.

### DETAILED DESCRIPTION OF THE PREFERRED EMBODIMENTS

An integrated intelligent inter/intra-networking device and corresponding methods are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

Unless specifically stated otherwise as apparent from the following discussion, it is appreciated that throughout the description, discussions such as “processing” or “computing” or “determining” or “switching” or “converting” or the like, refer to the action and process of a computing system or networking system that manipulates and transforms data represented as physical (electronic) quantities within the system's registers and memories into other data similarly represented as physical quantities within the system registers or memories or other such information storage, transmission or display devices.

It should be noted that the language used in this disclosure has been principally selected for readability and instructional purposes, and may not have been selected to delineate or circumscribe the inventive subject matter, resort to the claims being necessary to determine such inventive subject matter. References to numbers without their subscripts (e.g., 105) are understood to reference all instances of the subscripted numbers (e.g., 105(a)).

A. Overview of the Integrated Intelligent Inter/Intra-Networking Device

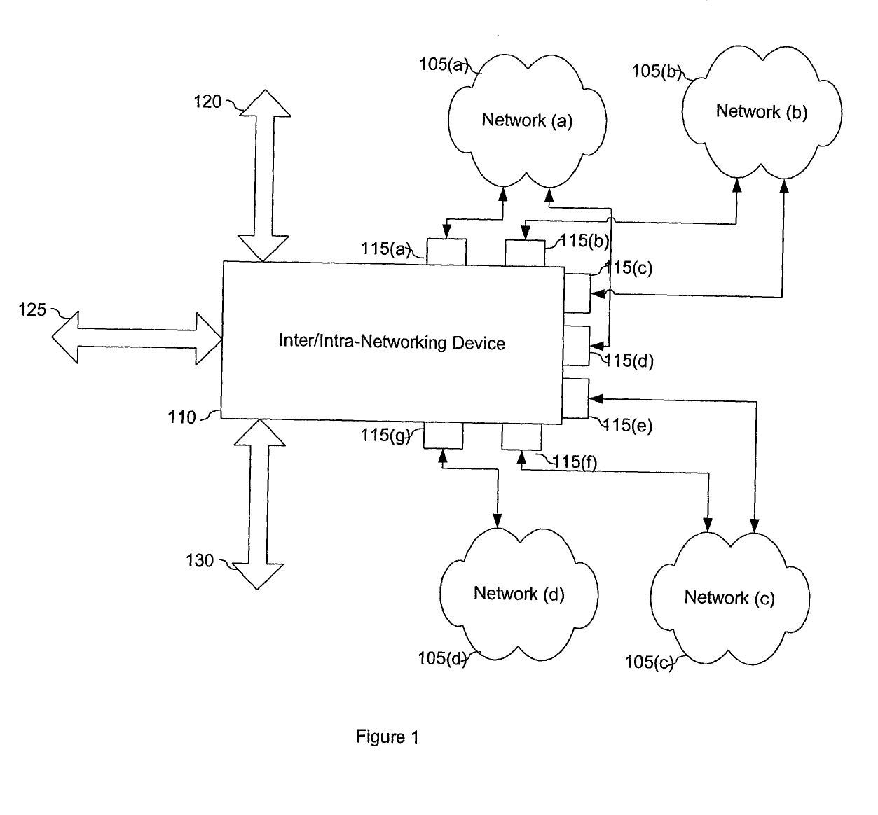

The present invention is directed towards an integrated intelligent inter/intra-networking device. In one embodiment, the device may be used in an enterprise environment to intelligently couple various networks into a single enterprise infrastructure. Generally, these networks operate on various types of transmission medium including copper, fiber optic or wireless connections. This enterprise environment, including an embodiment of the present invention, is depicted in FIG. 1.

A networking device 110 is coupled to at least one network 105 and a plurality of access interfaces. The access interfaces typically couple the networking device 110 to wide area networks (“WANs”), external wireless networks, or Internet service providers (“ISPs”). According to this embodiment, a first access interface 120 is coupled to a copper-based network-accessing device. Examples of copper-based network-accessing devices include digital subscriber lines (“DSL”), integrated service digital network (“ISDN”) interfaces, cable connections, T1/E1, and plain old telephone system (“POTS”) lines. A second access interface 125 is coupled to a fiber optic accessing device. Examples of fiber optic accessing devices include a fiber to the home (“FTTH”) connection and a metro area network (“MAN”) interface. A third access interface 130 is coupled to a wireless accessing device. Examples of wireless accessing devices include wireless access point interfaces (e.g., transceivers) and wireless ISPs. This structure accommodates multiple devices with different protocols, technology and mediums. As a result of the diversity of mediums with which the networking device 110 may interface, a network or enterprise administrator may utilize various existing or future WANs or ISPs in constructing and maintaining an enterprise.

The networking device 110 may interface with either a single local area network (“LAN”) or multiple LANs. An embodiment, as shown in FIG. 1, provides for the networking device 110 to interface with four LANs through a plurality of network ports 115. The port configuration may be designed and updated by a network administrator as he/she desires. In this design, factors such as required bandwidth and quality of service (“QoS”) are typically considered (i.e., as the number of ports increase, the bandwidth and QoS performance increase). One such example is having a first LAN 105(a) coupled to two ports 115(a) and 115(d). Similarly, a second LAN 105(b) is coupled to ports 115(b) and 115(c), and a third LAN 105(c) is coupled to ports 115(e) and 115(f). A fourth LAN is coupled to a single port 105(d) and likely does not have the amount of bandwidth as any of the first three LANs. The above described design may be implemented where multiple business, operating their own LAN, are housed within the same office building. Comparatively, the networking device 110 may interface with a single LAN if, for instance, a single business is solely operating within an office building.

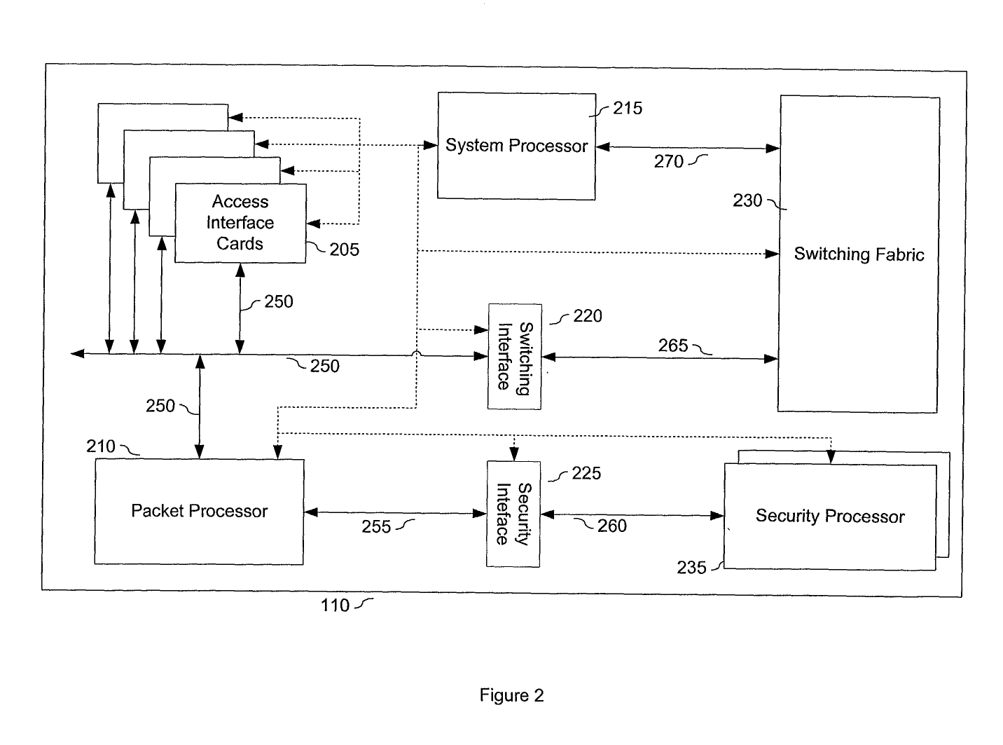

FIG. 2 shows a block diagram of the inter/intra-networking device. A plurality of access interface cards 205 corresponding to the above-described access interfaces. Each access interface card 205 corresponds to a specific access interface. For example, a first access interface card may control a POTS access interface. Additionally, a second access interface card may control a FTTH connection and a third access interface card may control a Bluetooth wireless connection. The access interface perform multiple tasks including:

1. Convert received packets so that they may operate on a common medium, typically copper; and

2. Control access and transmission of packets from each access interface.

The access interface cards 205 are coupled to and controlled by a system processor 215. Packets are sent from the access interface cards 205 to a packet bus 250 via parallel connections 250. From the packet bus 250, the packets are transmitted to packet processor 210. Packets are blocks of data with a header that contains information descriptive of the block of data.

The access interface cards may be secured within the inter/intra-networking device by a plug and play device, hot-swap device, or any other device that allows them to be easily removed and upgraded. This feature allows a network administrator to easily upgrade the networking device by merely replacing broken or out-of-date access interface cards with new cards that interface with the desired networking medium. For example, a network administrator may upgrade an enterprise by including a wireless network within a pre-existing enterprise. This upgrading process simplifies the typically complex job of upgrading and/or integrating networks within an enterprise infrastructure.

The packet processor 210 is directly coupled to a security interface 225 via connection 255. This security interface 225 is coupled to a security processor 235 via connection 260 and interfaces the packet processor 210 to the security processor 235. Additionally, the packet processor 210 is coupled to a switching interface 220 via packet bus 250. This switching interface 220 is coupled to a switching fabric 230 via connection 265 and interfaces the packet bus 250 to the switching fabric 230.

The packet processor 210 performs multiple packet analyses and functions upon receipt of a packet from the packet bus 250. Additionally, the packet processor 210 extracts and analyzes relevant management data included within packets. This management data is used to create and maintain management tables such as policy, user, customer, network configuration and service tables. The packet processor 210 also extracts and analyzes relevant enterprise customer data included within packets. This enterprise customer data is used to create and maintain enterprise customer tables containing information such as customer name, customer identification, and other enterprise customer data that may be invoked to perform various security and intrusion detection software functionalities.

The packet processor 210 performs various functions to create, maintain and control virtual private networks (“VPNs”) within the enterprise. For example, the packet processor 210 maintains various tables required for a properly functioning VPN such as site-to-site identification tables. These tables may include site identification, location, IP address of the networking device, identification of the central site, identification information of the networking device such as product number, software version, number and list of security associations from a particular site to other sites, and number and list of security associations from a particular site to a central site.

The packet processor 210 extracts and analyzes data within a packet to maintain a multi-site VPN in the following manner. Typically, within a multi-site connection, all traffic destined for a particular enterprise terminates at the head office node. In VPN connections, packets may or may not be encapsulated according to the Internet Protocol Security (“IPSec”) protocol. If the packet is IPSec encapsulated, then the packet processor 210 decrypts the packet and analyzes the inner packet for necessary routing information (e.g., destination address). The inter/intra-networking device determines whether packet is destined for a device on an attached network. If the destination address is located on an attached network, the packet is routed accordingly. However, if the destination address is in another network branch, then the packet is encapsulated in another IPSec envelope and transmitted within the existing VPN tunnel to the corresponding destination branch.

If the packet is not encapsulated then the packet processor 210 analyzes the packet for necessary routing information (e.g., destination address). The inter/intra networking device determines whether the packet is destined for a device on an attached network. If the destination address is located on an attached network, the packet is routed accordingly. However, if the destination address is in another network branch, then the packet is encapsulated in a virtual private security (“VPSec”) envelope and transmitted to a remote networking device corresponding to the destination address.

The packet processor 210 performs various functions to create and maintain tables regarding attached LANs. In one embodiment, a LAN table contains information about the LAN configuration and may be accessed by a site number corresponding to the particular LAN. It is important to note, that the actual information included within a table depends on various factor such as the medium on which LAN operates. Devices operating on a wire LAN (e.g., copper-based) may have different configuration information than devices on a wireless LAN (e.g., Bluetooth compatible network). For example, information corresponding to wire-type device includes a switch number, a port number, an equipment number (MAC address), and an IP address. Comparatively, information corresponding to a wireless device includes a MAC address (for Bluetooth equipment, this address is the 48 bit IEEE 802 Bluetooth device address), as well as a virtual LAN number.

The packet processor 210 performs various functions to create and maintain a network address translation (“NAT”) table for devices on the enterprise. This table should contain one entry for each networked device and should map each local IP address into a globally registered IP address. As a result, the packet processor 210 may function as a NAT router due to the address translation described above. The packet processor 210 may also create and maintain a table containing a domain name server (“DNS”) table. Additionally, the packet processor 210 may create and maintain user information tables corresponding to users on the enterprise. Information within these tables may include the user's identification, access privileges, name, passwords, hosts, permissible VLANs, and other descriptive information of the user and his/her rights on the enterprise.

The packet processor 210 also provides various security functions that protect the integrity of the inter/intra-networking device, the enterprise, and attached devices. Included in these functions are multiple firewalls, tables of security associations and associated information, IPSec processing and databases, anti-virus programs, and port protection and blocking standards.

The security processor 235 is coupled to the packet processor 210 via the security interface 225. Packets are exchanged between the security processor 235 and the packet processor 210 through this security interface 225. The security processor 235 provides encryption/decryption functionalities to the inter/intra-networking device and works in conjunction with the packet processor 210 to analyze and process packets. These functionalities operate according to a variety of encryption protocols within the networking arena. One example of these security protocols that is typically used is IPSec and its corresponding sub-protocols.

The security processor 235 decrypts and encrypts packets according to a protocol defined standard architecture. For example, authentication header (“AH”) defines header structure and content for an encapsulated packet so that data origin may be authenticated. Additionally, encapsulating security payload (“ESP”) provides similar features described above as well as applying a specified encryption transform to the protected packet. It is important to note that the security processor 235 is not limited to a standard protocol when decrypting or encrypting; rather, numerous protocols may be combined or nested in order to maintain integrity and privacy within a particular VPN tunnel.

The security processor 235 utilizes other protocols, such as Internet Key Exchange (“IKE”), to negotiate keys and establish and manage security associations operating within the enterprise. The security processor 235 may use these other protocols to enhance a security protocol such as IPSec. For example, the security processor 235 may define a lifetime for an IPSec security association, provide anti-replay services, digital signature authentication and allow dynamic authentication of peers. As a result, the security processor 235 allows the enterprise to create and maintain VPN tunnels and security associations according to various protocols and standards.

The system processor 215 is coupled to the access interface cards 205, the packet processor 210, the switching interface 220, the security interface 225, the switching fabric 230 and the security processor 235 via control lines. The system processor 215 is also coupled to the switching fabric 230 via bus 270. The system processor controls each component by these control lines and performs such functions as configuration, supervision, maintenance and component co-ordination. Additionally, the system processor provides a graphical user interface (“GUI”) that allows a network manager access to the inter/intra-networking device. This GUI may operate according to Simple Network Management Protocol (“SNMP”), Command Line Interface (“CLI”), Socket Secure Layer (“SSL”) or other management/security protocols.

The GUI will allow a network manager to manage the entire enterprise, including devices on an attached network, from a local or remote site. Specifically, the network manager will be able to configure and utilize various network features within the inter/intra-networking device to manage the enterprise on both a network and device level. In so doing, various modules operating within the system processor 215 are implemented to perform various networking functions. For example, the system processor 215 may transfer files between devices on at least one attached network, push or pull various files, and manage devices on attached networks using various agents operating on the networks.

The system processor 215 coordinates with the packet processor 210 to perform various security functions and firewall intrusion detection operations. For example, the system processor 215 controls access to ports on the switching fabric 230 by initially configuring the ports as well as establishing security standards that may block certain packets from accessing the inter/intra-networking device. Additionally, the system processor 215 maintains back-up copies of all critical data stored within the packet processor 210, the security processor 235, and the switching fabric 230.

The system processor 215 also logs events that occur both within the inter/intra-networking device and on the attached networks. The system processor 215 will intermittently generate reports containing these enterprise events so that a network administrator may reach accordingly. Also, critical events within these reports may be highlighted for the network administrator. The system processor 215 may also periodically store necessary files and/or databases to an external computer for memory allocation purposes or for backing up certain files.

The switching fabric 230 is coupled to the packet bus 250 via the switching interface 220 and the system processor 215 via connection 270. The switching fabric 230 is also coupled to a plurality of network ports that connect to at least one private network or LAN. According to one embodiment, the switch provides two 1 gigabit ports and twenty-two 10/100 ports. It is important to note that these private networks may be LANs, wireless networks or any other type of network.

The switching fabric 230 comprises multiple routing and switching tables that allow the switching fabric 230 to transmit packets to an appropriate destination on an attached network. These tables will be indexed so that the switching fabric 230 will recognize packets from information within the header and an entry within the table will describe a port on which the packet should be transmitted. There are various implementations that create these tables. For example, header information may be hashed to create a data string. The data string identifies an entry in the table containing the pertinent routing information corresponding to the packet. It is important to note that other methods may be used that are well known in the art to route or switch packets within a switching fabric.

The switching fabric 230 may contain other information and functionalities. For example, the switching fabric 230 generally supports Internet Protocol version 4 (“Ipv4”) and Internet Protocol version 6 (“Ipv6”) and also reports any configuration and self-test errors. Additionally, the routing table within the switching fabric 230 may be static or dynamic. The routing table typically is configurable and adheres to defaults set by a routing function. Additionally, the routing table may be designed to report any configuration or self-test errors that occur to a network administrator.

B. Description of the Packet Processor

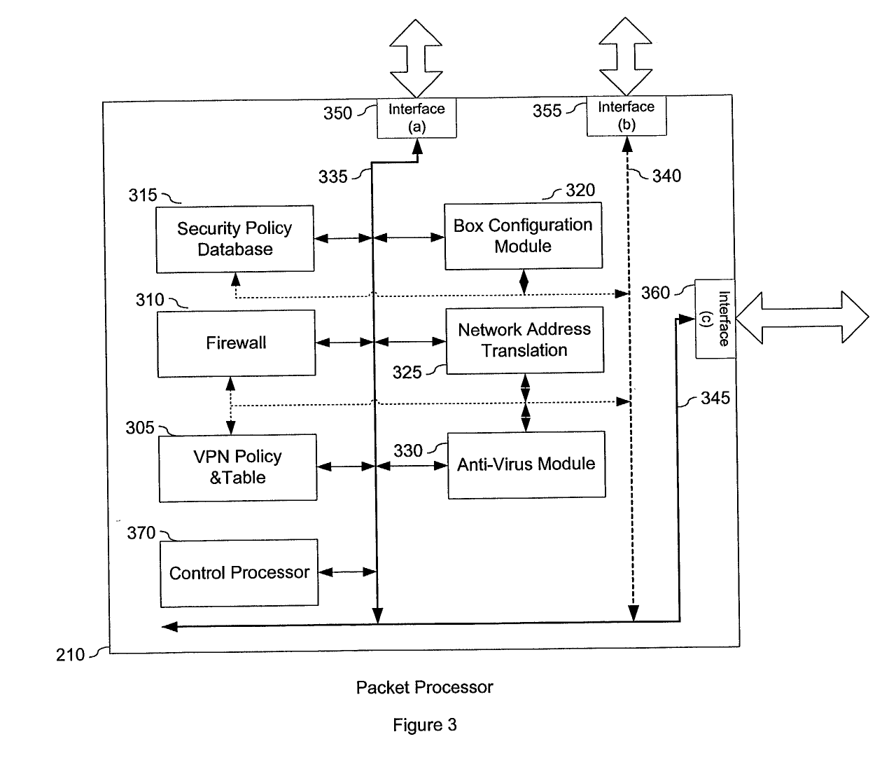

FIG. 3 shows a block diagram of the packet processor 210. The packet processor 210 has three interfaces that couple it to other components within the inter/intra-networking device. A first interface 350 couples the packet processor 210 to the packet bus 250 and is coupled to a first internal packet bus 335. This first interface 350 receives and transmits packets to the access interface cards 205 and the switching fabric 230. These packets are processed within various modules operating within the packet processor 210. A second interface 355 couples the packet processor 210 to the system processor 215 and is coupled to an internal control bus 340. The second interface 355 receives and transmits control data to the system processor 215. The system processor 215 uses this control to manage various modules operating within the packet processor 210. A third interface 360 couples the packet processor 210 to the security processor 235 and is coupled to a second internal packet bus 345. The third interface 360 receives and transmits packets to the security processor as well as encryption/decryption algorithms and security data.

A security policy database 315 is coupled to the first internal packet bus 335, the second internal packet bus 345, and the internal control bus 340. The security policy database 315 comprises a standard for specifying packet-filtering rules based on information found within a header of a packet. For example, security standards may be stored within the security policy database 315 based on source and destination addresses found in layer 3 Ipv4 or Ipv6 packet headers. A table entry corresponding to this example may contain entries such as the source IP address, source TCP/UDP port number, destination IP address, and the destination TCP/UDP port number. Once a packet is identified, security standards relating to the packet are stored as indexed entries to the packet. For example, security standards may include:

(1) discarding all source-routed packets;

(2) discarding all incoming packets from a local network;

(3) passing all packets that are part of an existing TCP connection;

(4) allowing all outgoing TCP connections; and

(5) passing all simple mail transfer protocol (“SMTP”) and domain name system (“DNS”) packets to a mail host.

The security policy database 315 may also contain an IPSec processing database that maintains an IPSec processing table. This table describes the services offered for IP datagrams and sequences and/or prioritizes these services. Typically, the IPSec processing table requires distinct entries for both inbound and outbound packet traffic. Examples of these IPSec processing table entries include:

(1) IPSec processing is to be applied to packet traffic or a packet must be discarded;

(2) If IPSec processing is applied, the entries include security association specification, IPSec protocols, modes, and algorithms that will be applied including any nesting requirements;

(3) A policy entry may include specification of the derivation of a security association database (“SAD”) entry, the IPSec processing table entry, and the packet.

(4) A set of parameters that support security association management using a destination IP address (may be a range of addresses as well as a wildcard address), a source IP address, name (user identification or system name), transport layer protocol, source and destination TCP/UDP ports.

Various modules operating within the packet processor 210 and other components within the inter/intra-networking device 110 access the security policy database 315 in order to perform security and intrusion detection functions. For example, a firewall module 310 containing multiple firewalls may access the security policy database 315 to retrieve a particular security standard or packet analysis algorithm.

The firewall module 310 is coupled to the first internal packet bus 335, the second internal packet bus 345, and the internal control bus 340. The firewall module 310 analyzes, isolates and discards packets according to security standards and filtering techniques within different firewall layers. The firewall module 310 may also provide a network address translation (“NAT”) function to map incoming IP addresses to local addresses of a VPN. Additionally, the firewall module 310 may include identification, authentication and access control of received packets from the interface access cards.

The firewall module 310 controls access to various functionalities and sites within a VPN. Various access rules may be defined within a table, such as the security policy database 315, or may be specified by a network administrator via a GUI. These access rules can be specified to a granular level of files or objects within the VPN and/or may be grouped together to form a single entity to apply a policy group for a general management of a VPN and attached devices thereon. Additionally, various filtering algorithms may be used to characterize packets received by the firewall module.

A first type of filtering algorithm provides content filtering of packets to define packet characteristics that will be applied to the access rules. According to this type of algorithm, packets are filtered according to information included within the packet header. For example, content filtering may be performed according to specific IP addresses or a certain uniform resource locator (“URL”) name. A user may be denied access to a particular site before leaving the firewall by comparing IP address or URL to a table defining access rights.

A second type of filtering algorithm provides stateful inspection of packet to identify states that the packet has completed. An example of inspection is IP spoofing detection where various states or histories of a packet are monitored in order to identify an attack pattern used to hack into various devices on an attached network. IP spoofing detection monitors packets sent from a particular source to various devices within a network. If packets are being sent to multiple devices in such a manner that is indicative of hacking techniques or other unwanted spoofing techniques, then access to the network from this particular source is blocked.

The firewall module 310 may also contain a network intrusion detection mechanism that monitors packets transmitted to or from specific devices on the enterprise. These devices are typically identified by a network administrator or may be identified by the inter/intra-networking device according to a pre-set algorithm. The network intrusion detection mechanism is typically based on anomaly detection and misuse detection. Anomaly detection identifies variation in usage patterns against a pre-established baseline usage pattern. Specifically, the network intrusion detection mechanism stores a baseline usage pattern and compares usage characteristics of received packets. For example, the network intrusion detection mechanism monitors usage pattern anomalies in log-ins, file access, and CPU utilization. If an anomaly is detected, then the packet is typically discarded and a message is generated and sent to a network administrator. Misuse detection identifies pre-defined known attack patterns in the packet traffic. For example, the network intrusion detection mechanism may monitor for large number of TCP connection requests to many different ports on a particular device; thereby identifying someone attempting a TCP port scan.

A VPN Policy & Table (“VPT”) 305 is coupled to the first internal packet bus 335, the second internal packet bus 345 and the internal control bus 340. The VPT 305 contains information about individual sites on the enterprise. As previously described, the VPT 305 may support single or multi-site VPNs and coordinates encryption/decryption functions with the security processor 235. The VPT 305 indexes various sites with corresponding security associations to other sites as well as to a central site. VPNs are maintained by decrypting encapsulated packets and retrieving routing information so that they may be transmitted within the appropriate tunnel. However, prior to transmission, the packet is re-encapsulated with an IPSec envelope.

A table of open security associations may also be maintained within the VPT 305. Procedures for authenticating a communicating peer, creation and management of security associations, key generation techniques, and threat mitigation (e.g., denial of service and replay attacks) are maintained within this table. These functions are necessary to establish and maintain secure communications in an Internet environment. The table may include any of the following fields corresponding to an entry:

(1) Sequence number for authentication header (“AH”) and encapsulated security payload (“ESP”) header;

(2) Sequence counter over-flow (a flag that indicates any further transmission will overflow a corresponding security association);

(3) Anti-replay window used to determine whether a packet is a replay;

(4) AH authentication algorithms and keys;

(5) ESP authentication algorithms and keys;

(6) ESP encryption algorithm and keys;

(7) Lifetime of a particular security association; and

(8) IPSec protocol mode initialization vector (e.g., tunnel, transport, wildcard).

The VTP 305 may also contain other security related tables and policy databases. For example, various IPSec sub-protocol information that support secure exchange of packets at the IP layer may be maintained within this table (e.g. authentication header and encapsulated security payload).

A box configuration table 320 is also maintained within the packet processor. The box configuration table 320 is coupled to the first internal packet bus 335, the second internal packet bus 340, and the internal control bus 340. Information describing a particular inter/intra-networking device is maintained within the box configuration table 320. For example, a product number, IP address, software version number, number of stacked switches in the device, switch identifier/product number of each switch, IP address of a Bluetooth access point, extended service set identification (“ESSID”) of a 802.11 access point, IP address of the IEEE 802.11 access point and the number of attached VLANs may all be stored within this table.

A network address translation (“NAT”) module 325 is included within the packet processor 210. The NAT module 325 is coupled to the first internal packet bus 335, the second internal packet bus 345, and the internal control bus 340. The NAT 325 module allows an attached LAN to use one set of IP addresses for internal traffic and a second set of addresses for external traffic. The NAT module 325 serves two primary purposes. First, it provides a firewall by hiding internal IP addresses from external devices. Second, it enables a LAN to increase the possible number of local IP addresses because there is no possibility to conflict with external IP addresses.

The NAT module 325 contains a table having an entry for each device on the enterprise. Using this table, the NAT module 325 maps local IP addresses and local TCP/UDP ports into globally registered IP addresses and assigned TCP/UDP ports. The NAT table contains site identification for each device to indicate where each device is located on the enterprise. A complete table maintained in the system processor 215 updates this site identification. Because all traffic going in and out of a particular site goes through the packet processor 210, the translation will not cause a conflict with other addresses and the packet processor 210 is functioning as a NAT router.

An anti-virus module 330 is also included within the packet processor 210. The anti-virus module 330 is coupled to the first internal packet bus 335, the second internal packet bus 345, and the internal control bus 340. The anti-virus module 330 provides an anti-virus agent that monitors devices on an attached network for viruses. Additionally, the anti-virus module 330 provides automatic updating of an anti-virus package. As a result, virus security is controlled by the inter/intra-networking device and any updates are centrally pushed onto various devices in the enterprise.

A first control processor 370 is also included within the packet processor 210. The first control processor 370 is coupled to the first internal packet bus 335, the second internal packet bus 345 and the internal control bus 340. The first control processor 370 controls each module and/or function performed within the packet processor 210 and coordinates this activity with the system processor 215.

C. Description of the Security Processor

The security processor 235 provides security functions to the inter/intra-networking device and cooperates with the packet processor 210 in performing these functions. The security processor 235 has two interfaces that couple it to other components within the inter/intra-networking device. A first interface 420 couples the security processor 235 to the packet processor 210 and is coupled to an internal packet bus 435. The first interface 420 receives and transmits packets to the packet processor 210. A second interface 425 couples the security processor 235 to the system processor 215 and is coupled to an internal control bus 430. This second interface allows the system processor to monitor and control various modules operating within the security processor 235.

An encryption/decryption module 440 operates within the security processor 235 to apply encryption/decryption functionalities to received encapsulated packets. Currently, packets are encrypted and decrypted using the Triple DES algorithm. However, as improved encryption algorithms are developed, the encryption/decryption module 440 may implement these algorithms. The encryption/decryption module 440 also supports ARCFOUR and Diffie Helman algorithms that may be used to encrypt and decrypt packets. Additionally, the encryption/decryption module 440 supports Layer Two Tunneling Protocol. This protocol enables Internet service providers to operate VPNs. As a result, the inter/intra-networking device may function within a VPN operated by an Internet service provider.

An authentication header (“AH”) module 405 operates within the security processor 235 to provide proof-of-data origin on received packets, data integrity, and anti-replay protection. The AH module 405 is coupled to the internal packet bus 435 and the internal control bus 430. The AH module 405 ensures proper authentication by encapsulating the entire packet. Thereafter, an AH header is attached so that the encapsulated packet may be routed. The AH header may contain various information such as source and destination IP addresses. A particular security key is attached to the header that allows a corresponding host to unwrap the encapsulated packet.

The AH module 405 also supports various AH modes in which encapsulated packets are transmitted. For example, AH tunnel mode encapsulates only the datagram and leaves the IP address and payload alone. Comparatively, a separate mode, AH transport mode, embeds an AH header between the IP address and the payload. Algorithms and methods corresponding to AH and its various modes may be solely implemented within the AH module 405 or may be imported to the packet processor 215 to be performed there.

An encapsulating security payload (“ESP”) module 410 also operates within security processor 235. The ESP module 410 is coupled to the internal packet bus 435 and the internal control bus 430. The ESP module provides proof-of-data origin on received packets, data integrity, and anti-replay protection in addition to data and limited traffic flow confidentiality. Similar to AH, ESP offers multiple modes in which data may be transmitted within a VPN.

If the ESP module 410 is operating in the tunneling mode, then both the IP address and payload are encrypted. Additionally, an ESP trailer is embedded in the packet and encrypted. Next, an ESP header is placed on the encrypted packet. As a result, both the data within the packet as well as the routing information are protected. Additionally, authenticating information may be appended to the end of the packet. Comparatively, if the ESP module 410 is operating in transport mode, then only the payload and the ESP trailer are encrypted. The header containing an IP address is not encrypted. As a result, the data within the packet is protected but the routing information is exposed. Algorithms and methods corresponding to ESP and its various modes may be solely implemented within the ESP module 410 or may be imported to the packet processor 215 to be performed there.

An Internet Key Exchange (“IKE”) module 415 also operates within the security processor 235. The IKE module 415 is coupled to the internal packet bus 435 and the internal control bus 430. The IKE module 415 exchanges public keys, authenticates senders, generates shared session keys, and establishes security associations. Specifically, the IKE module 415 contains the internet security association key management protocol (ISAKMP) developed by the Internet Engineering Task Force that generates the security associations.

The IKE module 415 provides a method for exchanging private keys over a non-secure network. These keys allow a recipient to decrypt a packet sent and encrypted at the other side of the connection. Specifically, these keys create a security association between two devices that allow packets to be securely sent across public networks.

A second control processor 450 is also included within the security processor 235. The control processor 450 is coupled to the internal packet bus 435 and the internal control bus 430. The second control processor 350 controls each module and/or function performed within the security processor 235 and coordinates this activity with the packet processor 210.

D. Description of the System Processor

The system processor 215 provides various system level functions within the inter/intra-networking device. For example, via control lines, the system processor 215 configures the components to function properly as well as coordinates and supervises the activities performed by the components. The system processor 215 may upgrade software and tables stored within the various components or devices on an attached network. Additionally, the system processor 215 may coordinate with the packet processor 210 to generate logging information for various purposes such as intrusion detection and statistics. The system processor 215 may also provide the switching fabric 230 with certain protocols required to properly switch packets to appropriate ports. The system processor 215 also provides an graphical user interface (“GUI”) that allows a network administrator to control various functions in the inter/intr-networking device. For example, through the GUI, a network administrator may block or limit access of packets from a particular source according to a desired level of security desired on the enterprise.

The system processor 215 comprises two interfaces. A first interface 505 couples the system processor to each component via control line buses and is coupled to an internal control bus 530. This first interface 505 allows the system processor 215 to send and receive data from each component within the inter/intra-networking device. As a result, the system processor 215 may control, coordinate or share various networking tasks with these other components. A second interface 525 couples the system processor 215 to the switching fabric 230 via bus 270 and is coupled to an internal control bus 530. Various protocols and routing information are sent through this interface to enable the switching fabric 230 to function properly.

A network manager 540 operates within the system processor 215. The network manager 540 is coupled to the internal control bus 530. The network manager 540 allows the inter/intra-networking device to perform various networking managing functions on attached networks. The network manager 540 and receives management data from devices operating on attached networks and analyzes it. Typically, agents operating on these devices generate this management data. Additionally, the network manager 540 may control various file transfers between devices or may push files to a particular device.

The network manager 540 provides a bootstrap protocol function which allows the inter/intra-networking device to provide an attached workstation its own IP address, an IP address of a boot-up server on the network and a file that allows the workstation to boot-up without requiring any accessing of local memory. The network manager 540 also provides a file transfer function that allows devices on the enterprise to transfer files between each other. This function may use the File Transfer Protocol (“FTP”) or the User Datagram Protocol (“UDP”). Additionally, the network manager 540 may provide Web-hosting support that allows network administrators to configure and maintain the enterprise through a Web interface. Moreover, the network manager 540 may allow multiple devices shared access to files stored on a Web server or other computing device on an attached network.

A routing manager 520 also operates in the system processor 215. The routing manager 520 is coupled to the internal control bus 530 and supervises any routing function performed within the switching fabric 230. The routing manager 530 provides relevant routing instructions, protocols, and information to the switching fabric 230 via the second interface 525. The routing manager 530 supports multiple routing protocols so that the inter/intra-networking device may switch various types of packets.

The routing manager 520 provides an address resolution protocol (“ARP”) used to convert an IP address into a physical address (e.g., an Ethernet address). Specifically, ARP is used to support IP over Ethernet applications. Using ARP, the routing manager 520 is able to identify a local address on an attached network corresponding to an IP address in a packet. Once this local address is identified, the switching fabric 230 may route the packet to the correct destination.

The routing manager 520 also provides dynamic allocation of IP addresses to devices on a network. With dynamic addressing, a device may have different IP addresses each time it connects to the network. In some instances, the device's IP address may change while still connected to the network. The routing manager 520 also supports a mixture of static and dynamic IP addressing, thereby allowing a network manager the option of assigning permanent IP addresses to specific terminal and allowing other terminals to receive their IP addresses dynamically.

The routing manager 520 supports various routing protocols so that the inter/intra-networking device may function as various networking devices. For example, the routing manager 520 supports the Open Shortest Path First (“OSPF”) protocol that routes packets to a destination using the shortest path across the network. Because the routing manager 520 supports OSPF and other Interior Gateway Protocols, the inter/intra-networking device may function in a single autonomous system as a network router. Additionally, the routing manager 520 supports other protocols such as the Routing Information Protocol (“RIP”) that supplies necessary routing information to minimize the number of hops between a source and destination address across a network.

The routing manager 520 also supports the Internet Group Management Protocol (“IGMP”) so that it may report multicast memberships to any immediately-neighboring multi-cast router. This multicasting is integral to IP and allows the inter/intra-networking device to provide security features like IPSec as well. The routing manager 520 also offers quality of service (“QoS”) functions. Specifically, the routing manager 520 controls a QoS switch that supports various numbers of QoS queues servicing a network port. The routing manager 520 allows header information to be mapped to a QoS field within the security processor 520 so that the corresponding packet may be switching to the correct QoS queue.

A port access control module 510 also operates within the system processor 215 and is coupled to the internal control bus 530. This port access control module includes an external GUI that allows a network administrator to specifically identify constraints or blocks to ports within the switching fabric 230. Additionally, the network administrator may define general security characteristics so that the port access control module may dynamically adjust constraints on ports as network environments change.

An event manager 515 also operates within the system processor 215 and is coupled to the internal control bus 530. The event manager 515 contains multiple tables corresponding to the inter/intra-networking device as well as each attached network. Agents operating on various devices on the networks transmit network events to the event manager. These network events are stored and indexed within tables corresponding to the network on which the event occurred. Also, events occurring within the inter/intra-networking device are stored and indexed within another table. The event manager 515 intermittently generates reports for a network manager and may highlight important events that the network manager may want to address quickly.

A third control processor 550 may also be included within the system processor 215 and is coupled to the internal control bus 530. The third control processor 550 controls each module and/or function performed within the system processor 215 and coordinates this activity with the packet processor 210.

E. Packet Security and Routing

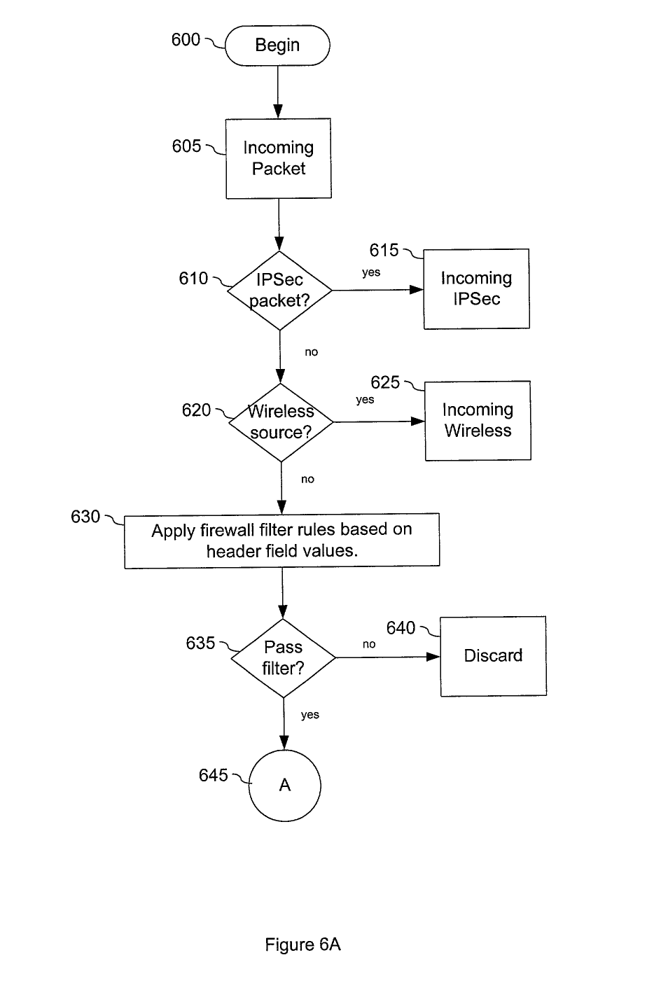

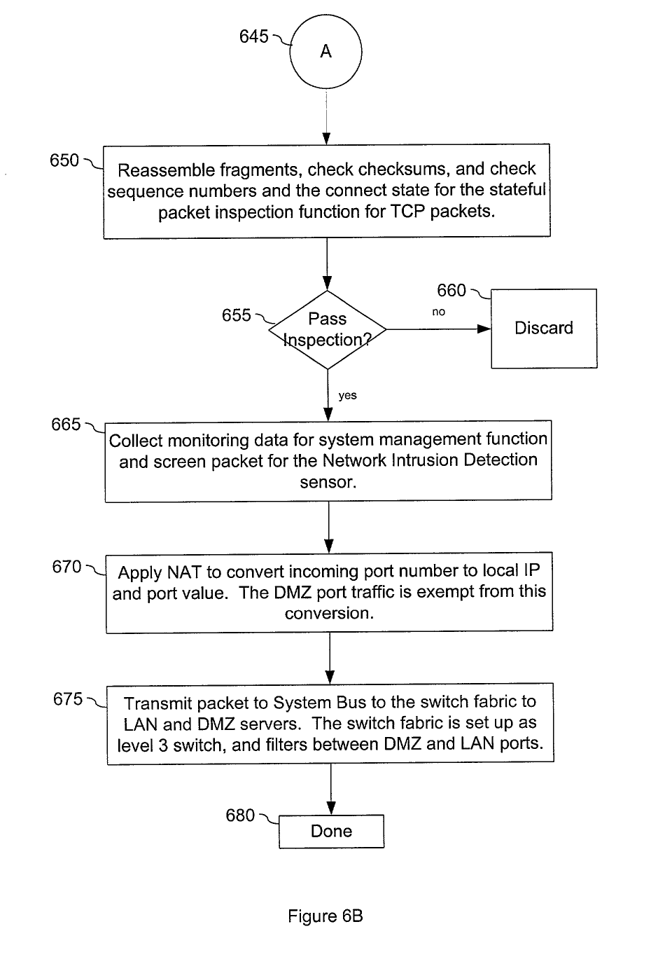

Having described the structure of the inter/intra-networking device, FIGS. 6A and 6B show general flowcharts describing a method for receiving, securing and routing packets received from access interfaces attached to a WAN or wireless network according to the present invention. A packet is received from an access interface, processed by a corresponding access interface card, and transferred to the packet bus. The packet processor receives 605 the incoming packet and performs various functions on the packet described below. The packet processor identifies a packet type corresponding to the received packet. For instance, the packet may be identified 610 as a VPN packet (e.g., IPSec packet) and processed 615 in a particular manner discussed later in more detail. Also, the packet may be identified 620 as a wireless packet and processed 825 in according to another method discussed later in more detail.

If the packet is not a VPN or wireless packet, then firewall-filtering rules are applied 630 to specific header field values within the packet. As described above, various types of rules may be applied and defined by a network administrator such as both content and state filtering rules. If the packet does not pass the firewall then it is discarded 640. However, if the packet passes the filter, then fragments are reassembled, and checksums, sequences, and connect state for stateful packet inspection are checked 650 for TCP packets. If the packet does not pass these inspections, then it is discarded 660. However, if the packet passes these inspections, then a network intrusion detection sensor is applied 865 to the packet. Additionally, any management or monitoring data within the packet is transmitted to the network manager for processing.

The packet's incoming port number is converted 670 to a local IP address and port value by the NAT 325. Once a local IP address and port value are determined, the packet is transmitted 675 to the switching fabric for transmission to an appropriate LAN. The switching fabric performs a layer 3 switching operation on the packet during this transmission according to the local IP address and port value.

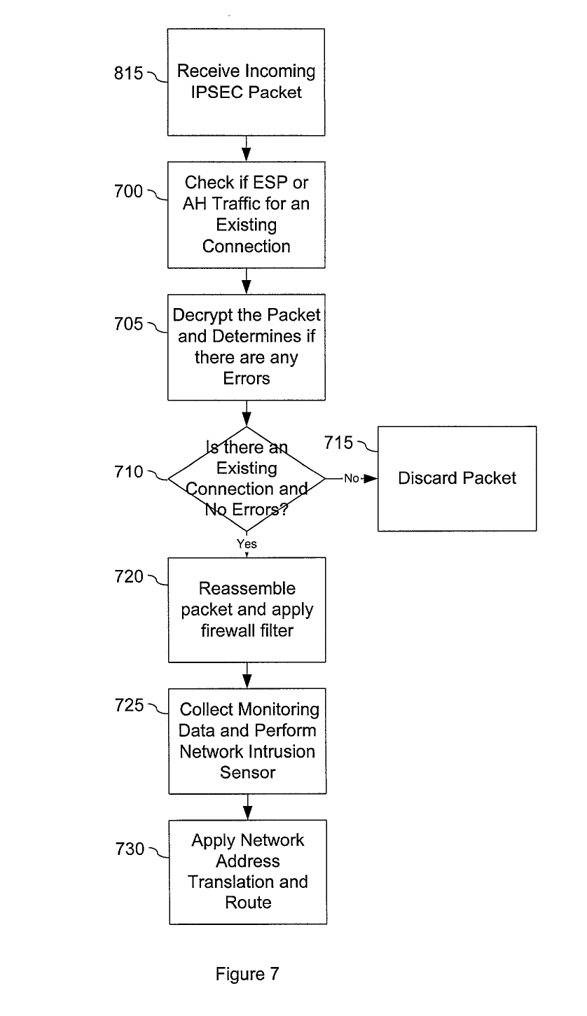

FIG. 7 is a flowchart describing a method for securing and routing a VPN packet according to the present invention. As described above, a packet is identified by the packet processor as a VPN (e.g., IPSec) packet. Next, VPN functions are performed to create or maintain a secure connection between the source and destination devices. One such method is described below describing such a method in accordance with the IPSec protocols and standards.

Once the packet is identified 615 as an IPSec packet, the packet processor 210 and/or security processor 235 checks 700 if the packet belongs to an ESP or AH existing traffic connection. The packet is then decrypted 705 and analyzed for any errors within the packet itself. If the packet is not error-free and/or there is not an existing connection, then the packet is discarded 715. However, if the packet is error-free and there is an existing connection, then the packet is reassembled 720 and a set of firewall-filtering rules are applied. If the packet passes these firewall-filtering rules, then a network intrusion sensor is applied 725 as described above as well as monitoring data is collected from within the packet. Finally, the packet's incoming port number is converted 730 to a local IP address and port value by the NAT 325. Once a local IP address and port value are determined, the packet is transmitted to the switching fabric for transmission to an appropriate LAN. This switching fabric performs a layer 3 switching operation on the packet during this transmission.

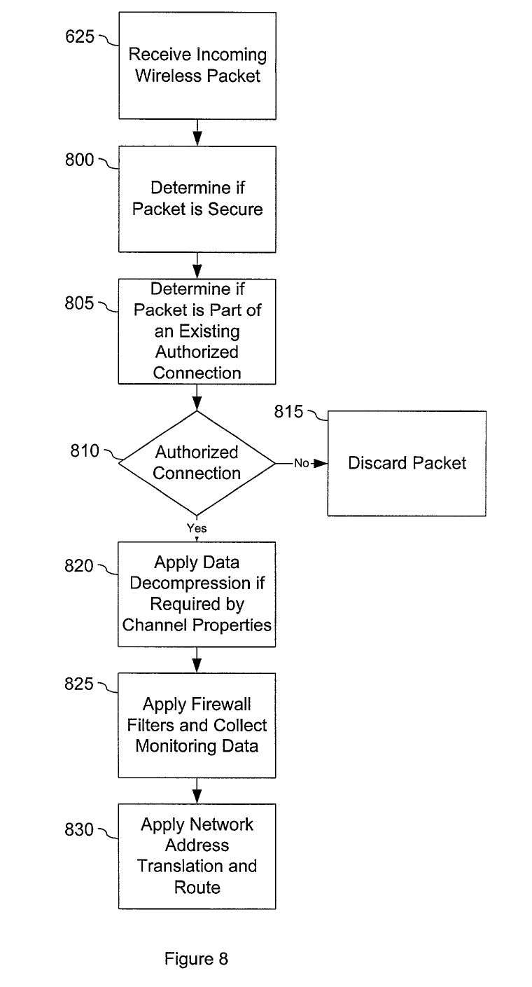

FIG. 8 is a flowchart describing a method for securing and routing a wireless packet according to the present invention. As described above, a packet is identified by the packet processor as a wireless packet. Once the packet is identified 625 as an incoming wireless packet, the packet processor 210 and/or security processor 235 checks 800 if the packet is secure. This security check requires that an existing connection be identified 805, and that this connection has been authorized. If there is not an authorized existing connection then the packet is discarded 815. However, if an authorized existing connection exists corresponding to this packet, a data decompression function may be performed 820 as defined by channel properties of the connection. These channel properties may be stored within the packet processor and indexed to the channel.

A set of firewall-filtering rules is applied as described above such as content and/or state filtering. If the packet passes these firewall-filtering rules, then a network intrusion sensor is applied 825 as described above as well as monitoring data is collected from within the packet. Finally, the packet's incoming port number is converted 830 to a local IP address and port value by the NAT 325. Once a local IP address and port value are determined, the packet is transmitted to the switching fabric for transmission to an appropriate LAN. This switching fabric performs a layer 3 switching operation on the packet during this transmission.

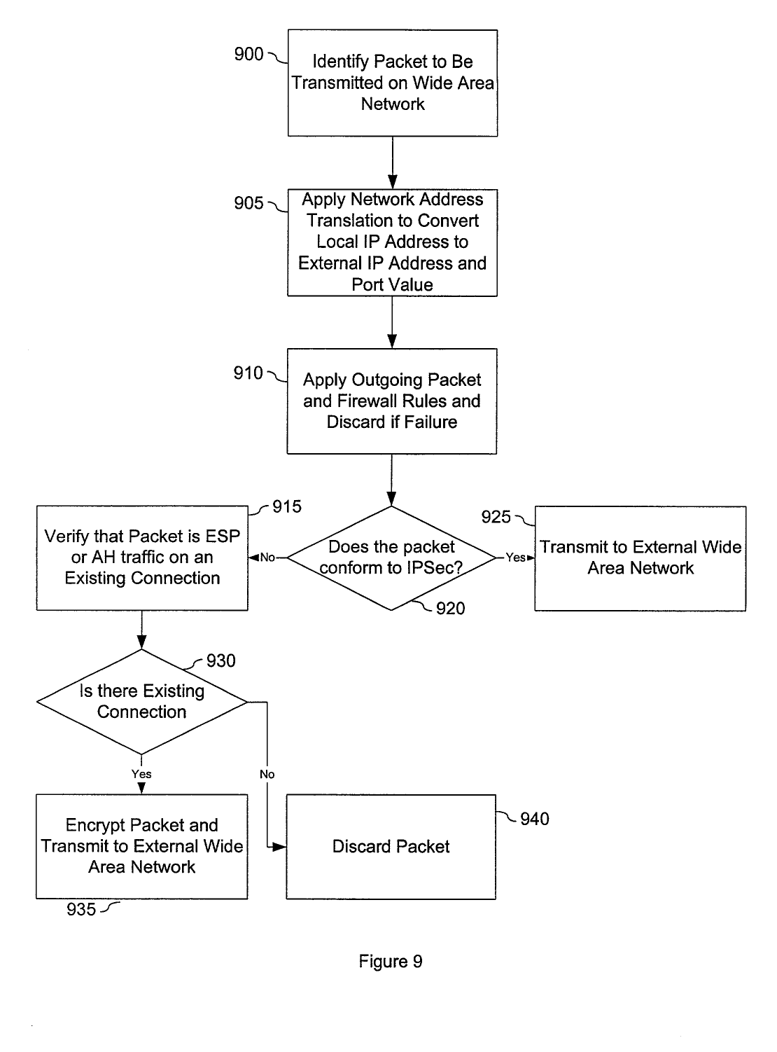

FIG. 9 is a flowchart describing a method for securing and routing packets received from LAN or private network to WAN. A packet is received from the switching fabric via a port coupled to an attached LAN or private network. This packet is transferred to the packet processor 210 for processing. This packet is first identified 900 by the packet processor as a packet that will be transmitted on a wire or fiber WAN. This identification is accomplished by analysis of information included within the packet's header fields.

The NAT 325 converts 905 a local address within the header to an external IP address and port value. This conversion allows the packet to be routed onto an appropriate WAN. The firewall 310 applies various firewall-filtering rules 910 to the packet such as content and state filtering. If the packet fails these rules, it is discarded. Next, the packet processor 210 and/or the security processor 235 determine if the packet corresponds to an existing connection within a VPN. If the packet is not a VPN (e.g., IPSec) packet, then the packet is transmitted to an external WAN via a particular access interface.

If the packet is found to be a VPN packet, then the packet processor 210 and/or the security processor 235 performs various functions that create and/or maintain this VPN connection. For example, the following describes functions that are applied to a VPN packet corresponding to IPSec protocols and standards. As mentioned above, an existing connection must be verified. In the case of an IPSec packet, the packet processor 210 verifies 915 that either an ESP or AH connection exists. If such a connection cannot be found, then the packet is discarded 940. However, if an ESP or AH connection is identified, then the security processor 235 encrypts 935 the packet according to the specific protocol corresponding to the connection. For example, as described above, both ESP and AH connections may operate in multiple modes (e.g., tunnel or transport mode). Each of these modes has its own set of algorithms for packet encryption and decryption. As a result, in order for the packet to be decrypted at the destination, the packet must be encrypted according to the proper encryption algorithms.

Once the packet has been encrypted, the packet is transmitted onto an external WAN corresponding to the external IP address and port value generated by the NAT. This transmission occurs over a corresponding access interface.

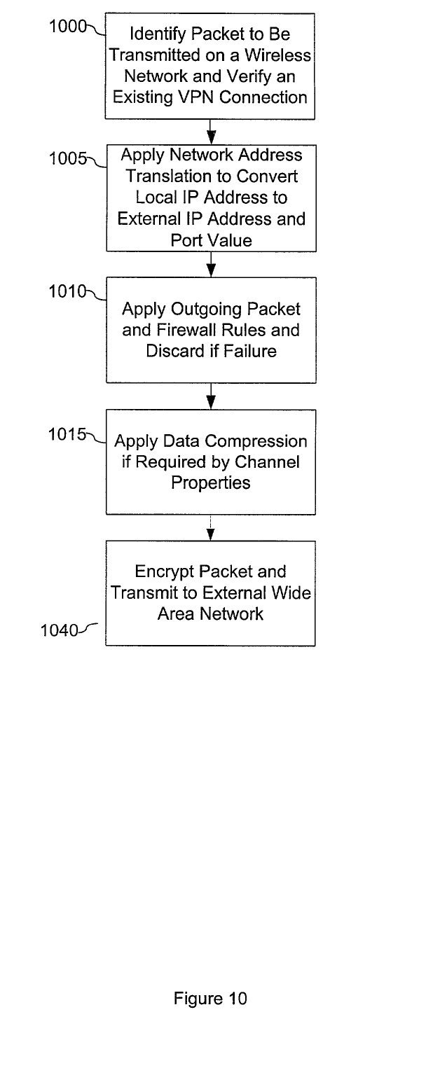

FIG. 10 is a flowchart describing a method for securing and routing packets received from LAN or private network to an external wireless network. A packet is received from the switching fabric via a port coupled to an attached LAN or private network. This packet is transferred to the packet processor 210 for processing. This packet is first identified 1000 by the packet processor as a packet that will be transmitted on an external wireless network. This identification is accomplished by analysis of information included within the packet's header fields. Additionally, the packet processor 210 verifies that an existing VPN wireless connection exists for the packet. If such a connection does not exist, then the packet is discarded. However, if the connection exists the packet is processed further by the packet processor 210. This verification may be done by analyzing the packet according to IPSec protocols and standards discussed above.

The NAT 325 converts 1005 a local address within the header to an external IP address and port value. This conversion allows the packet to be routed onto an appropriate external wireless network. The firewall 310 applies various firewall-filtering rules 1010 to the packet such as content and state filtering. If the packet fails these rules, it is discarded. Next, the packet processor 210 applies appropriate data compression function 1015 to the packet corresponding to connection's channel properties. These properties are stored within the packet processor 210 the packet processor 210 and/or the security processor 235 determine if the packet corresponds to an existing connection within a VPN.

Prior to transmission on an external wireless network, the packet must be encrypted 1040 according to the existing channel. For example, if the channel is an AH or ESP channel, then the packet is encrypted accordingly. After the packet is encrypted, the packet is transmitted to an appropriate wireless network interface.

While the present invention has been described with reference to certain preferred embodiments, those skilled in the art will recognize that various modifications may be provided. Variations upon and modifications to the preferred embodiments are provided for by the present invention, which is limited only by the following claims.

We claim:

1. An integrated networking device comprising:
a first access interface within a plurality of access interfaces, the first interface coupled to a first network and adapted to transmit packets to the first network and receive packets from the first network;
a second access interface within the plurality of access interfaces, the second interface coupled to a second network and adapted to transmit packets to the second network and receive packets from the second network, the second network operating on a different medium than the first network;
a packet processor coupled to the plurality of access interfaces, the packet processor adapted to identify a packet type and provide packet security within the device, the packet processor comprising;
a packet-filtering firewall for isolating and analyzing packets according to their content in order to prevent unauthorized access to an attached network;
a stateful-filtering firewall for isolating and analyze packets according to their state information in order to prevent unauthorized access to an attached network;
a security processor coupled to the packet processor, the security processor adapted to encrypt packets prior to transmission onto the first network and decrypt packets after reception from the first network;
a switching fabric coupled to the plurality of access interfaces, the packet processor, and a plurality of network ports, the switching fabric adapted to transmit packets to a corresponding network port according to a routing protocol within the switching fabric; and
a system processor coupled to the plurality of access interfaces, the switching fabric, the packet processor, and the security processor, the system processor adapted to manage the networking device.

2. The device of claim 1 wherein the first access interfaces couples to a copper-based network.

3. The device of claim 1 wherein the first access interface couples to a fiber optic network.

4. The device of claim 1 wherein the first access interface a transceiver adapted to communicate with a wireless network.

5. The device of claim 1 wherein the packet processor comprises a network address translation module for managing networking policy, configuration, and service for at least one of the attached networks.

6. The device of claim 5 wherein the network address translation module comprises:
an address resolution protocol module for converting an Internet Protocol address to a data link controlled address;
a device configuration table for storing configuration data regarding at least one device on the first network;
a user information table for storing user and customer information.

7. The device of claim 5 wherein the network address translation module dynamically assigns Internet Protocol addresses to at least one device on an attached network.

8. The device of claim 1 wherein the packet processor comprises a box configuration module for storing descriptive data relating to the inter/intra-networking device and corresponding ports.

9. The device of claim 1 wherein the packet processor comprises a security policy database for storing various standards for specifying packet-filtering rules based on information found within a header of a packet.

10. The device of claim 1 wherein the packet processor comprises an anti-virus agent for monitoring at least one connected device on the first network for computer viruses.

11. The device of claim 1 wherein the packet processor comprises an intrusion detection module for inhibiting hacking into the inter/intra-networking device by monitoring packets received by the networking device.

12. The device of claim 1 wherein the packet processor comprises a virtual private network policy and table module for implementing a virtual private network.

13. The device of claim 12 wherein the virtual private network policy and table module comprises:
an Internet Protocol header authentication module for providing connectionless integrity and data origin for Internet Protocol data packets;
an encapsulated security payload module for conveying encrypted data in an Internet Protocol datagram; and
an encryption key module for establishing security associations and cryptographic keys within the first network.

14. The device of claim 1 wherein the packet processor comprises a layer two tunneling module for enabling Internet service providers to operate virtual private networks within the first network.

15. The device of claim 1 wherein the security processor comprises an encryption/decryption module for creating a message for digital signatures corresponding to packets received from the packet processor.

16. The device of claim 15 wherein the encryption/decryption module verifies digital signatures according to the ARCFOUR standard.

17. The device of claim 1 wherein the security processor comprises an internet key exchange module dynamically negotiating security associations and enabling secure communication.

18. The device of claim 1 wherein the security processor comprises an authentication header module for encrypting and decrypting packets according to the authentication header protocols and standards.

19. The device of claim 1 wherein the security processor comprises an encapsulating security payload module for encrypting and decrypting packets according to the encapsulation security payload protocols and standards.

20. The device of claim 1 wherein the routing table is stores routing information for transmitting packets to at least one port within the plurality of ports.

21. The device of claim 1 wherein the switching fabric comprises a switching table that stores switching information for transmitting packets to at least one port within the plurality of ports.

22. The device of claim 1 wherein the system processor comprises a graphical user interface for allowing a network manager to configure and modify network settings on the networking device.

23. The device of claim 1 wherein the system processor comprises a network manager for controlling file transfers between a first device and a second device, the first device operating on the first network.

24. The device of claim 23 wherein the network manager for managing hypertext files in at least one device on the first network.

25. The device of claim 1 wherein the system processor comprises a network management module for managing the first network attached to the networking device.

26. The device of claim 25 wherein the network management module further receives and responds to management information from agents operating on at least one device on the first network according to the Simple Network Protocol.

27. The device of claim 26 wherein management information from agents is stored within a management information database.

28. The device of claim 1 wherein the system processor comprises a routing manager for controlling routing functions performed within the inter/intra-networking device.

29. The device of -claim 28 wherein the routing manager supports host address and performs host address translation.

30. The device of claim 29 wherein the routing manager comprises:
an open shortest path first module for determining a path across an attached network according to the Open Shortest Path First Protocol; and
a routing information module for determining a path across an attached network according to the smallest hop count between source and destination.

31. The device of claim 1 wherein the system processor comprises a routing manager for reporting multicast group memberships to any immediately neighboring multicast routing device.

30. The device of claim 1 wherein the system processor comprises a routing manager for supporting multiple quality of service packet characteristics and corresponding internal queues.

31. A method for networking computing devices operating on a plurality of networks operating on different mediums, the method comprising:
receiving a first packet from a first network via a first access interface on a networking device;
receiving a second packet from a second network via a second access interface on a networking device, the second network operating on a different medium than the first network;
identifying a packet type corresponding to the first packet;
applying a packet-filtering firewall to analyze the first packet according to its content in order to prevent unauthorized access to a device on the first network;
applying a stateful-filtering firewall to analyze the first packet according to its state in order to prevent unauthorized access to the device on the first network;
screening the first packet using a network intrusion detection sensor to prevent hacking into the device on the first network;
storing monitoring data regarding the first packet for use in managing the first network;
applying a network address table to convert an incoming port number to a local Internet Protocol or port value; and
switching the first packet to a corresponding network port according to a switching table.

32. The method of claim 31 wherein the step of identifying a packet type further comprises:
identifying whether the first packet is an Internet Protocol security encrypted packet;
decrypting the first packet in order to determine whether there are errors within the first packet;
recover routing information corresponding to the first packet that may have been lost doe to the errors;
determining whether there is an existing virtual connection in a network corresponding to the first packet;
encrypting the first packet; and
transmitting the first packet according to routing information corresponding to the first packet.

33. The method of claim 32 wherein an existing virtual connection is identified by analyzing an authenticated header corresponding to the first packet.

34. The method of claim 32 wherein an existing virtual connection is identified by analyzing an encapsulated security payload corresponding to the first packet.

35. The method of claim 31 wherein the step of identifying a packet-type further comprising:
identifying whether the first packet as a wireless packet;
determining whether the first packet is part of an existing connection that has been previously authorized; and
transmitting packet according to properties of the previously authorized channel.

36. The method of claim 31 further comprising:
creating a configuration table relating to devices on the first network;
maintaining the configuration by analyzing management data within the first packet; and
using the configuration table to manage the first network.

37. The method of claim 31 further comprising:
creating a user information table containing user and customer information relating to at a device on the first network;
maintaining the user information table by analyzing user data within the first packets; and
using the user information table to manage at least one device on the first network.

38. The method of claim 31 further comprising dynamically assigning Internet Protocol addresses to at least one device on the first network.

39. The method of claim 31 further comprising monitoring at least one device on the first network for viruses using an anti-virus agent.

40. The method of claim 31 further comprising configuring port access on the networking device according to a desired security standard.

41. The method of claim 31 further comprising scanning the first packet using an intrusion detection sensor to inhibit hacking into a device on the first network.

42. The method of claim 31 further comprising creating a message for a digital signature corresponding to the first packet.

43. The method of claim 42 further comprising verifying the digital signature according to ARCFOUR standards.

44. The method of claim 31 further comprising controlling file transfers between a first and second device, the first device operating on the first network and the file transfer performed according to the File Transfer Protocol.

45. The method of 31 further comprising creating a Web page stored in a device on the first network.

46. The method of claim 45 further comprising maintaining a Web page stored in a device on the first network.

47. The method of claim 31 further comprising reporting multicast group memberships to any immediately neighboring multicasting routing device.

48. The method of claim 31 further comprising switching the first packet according to quality of service characteristics corresponding to the first packet.
